(19) United States
(12) Patent Application Publication
(10) Pub. No.: US 2005/0036568 A1
(43) Pub. Date: Feb. 17, 2005

(54) Fast settling data slicer comprising a low-pass filter with switchable cut-off frequency and a notch-filter

(76) Inventors: Hendricus Clemens De Ruijter, Hilversum (NL); Marinus Hendrikus Doornekamp, Amersfoort (NL)

Correspondence Address: PHILIPS INTELLECTUAL PROPERTY & STANDARDS, P.O. BOX 3001, BRIARCLIFF MANOR, NY, 10510, US

(21) Appl. No.: 10/502,521

(22) PCT Filed: Dec. 23, 2002
(86) PCT No.: PCT/IB02/05726

(30) Foreign Application Priority Data
Jan. 29, 2002 (EP) 02075349.7

(51) Int. Cl. H04L 27/06

(52) U.S. Cl. 375/316

(57) ABSTRACT

A data slicer circuit for extracting data from a received analogue signal having a preamble and a data portion with the data. The circuit comprises a low pass filter for obtaining a DC value of the received signal, and a comparator for comparing the received analogue signal to the DC value of the received signal. In dependence on the comparison of the received analogue signal to the DC value of the received signal, the comparator generates a digital bit stream. A filter for rejecting the preamble frequency receives analogue signal and feeds a filtered signal to the low pass filter. By rejecting the preamble frequency, before or after, the low pass filter a shorter settling time can be obtained.

### FIELD OF THE INVENTION

The invention relates to data slicer circuits Data slicers are circuits, which are used in wireless receiver systems to receive an analogue demodulated data signal and convert it to a digital bit stream or data signal for use in processors and other digital circuits. In particular, data slicers are used in digital communication systems such as DECT cordless telephone handsets and base stations, GSM mobile phones, Bluetooth short-range RF communication, etc.

### BACKGROUND OF THE INVENTION

Eg in digital communication systems such as DECT, data are transmitted in bursts, where each burst has a standardised preamble followed by the actual data. The purpose of the preamble is to “alert” the receiver that data are underway and to provide bit synchronisation for synchronising the receiver. The preamble usually consists of a series of alternating one's and zero's for a predetermined period of time. An important aspect of a data slicer is its settling time, which is the time from the first received preamble bit until the first data bit is reliably detected by the slicer. Short preambles require correspondingly fast settling data slicers. In general, however, fast data slicers will often not suppress the preamble sufficiently, which will result in degraded sensitivity.

FIG. 1 shows a receiver with a conventional data slicer circuit with a demodulator receiving a radio frequency signal from a receiving antenna. The demodulator outputs a demodulated, ie a down-converted, signal superimposed on a DC signal plus some high frequency noise. The output signal from the demodulator is fed to a first input of a comparator and to a low pass filter feeding into a second input of the comparator. The low pass filter has a 3 dB cut-off frequency well below the preamble frequency and the data rate, and the output is therefore the DC value Vdc of the output from the demodulator. The low pass filter is a first order RC filter with two resistors R1 and R2 in series and a switch connected in parallel with one of the resistors. During reception of the preamble, the switch is closed, whereby the low pass filter is determined by the resistor R2 and the capacitor C, which gives a short time constant that enables reasonably fast settling of the data slicer within the preamble time frame. After reception of the preamble the switch is opened, whereby the low pass filter is determined by the resistors R1+R2 and the capacitor C, which gives a longer time constant and a lower cut-off frequency and thus a stable DC value and also good noise suppression. The comparator thus receives directly the analogue demodulated signal and the DC component thereof. The output of the comparator is a digital bit stream representing the data in the analogue demodulated signal.

The cut-off frequency of the low-pass filter in FIG. 1 must be fairly low in order to suppress the preamble sufficiently, and a low cut-off frequency inherently results in a corresponding high time constant and a long settling time of the data slicer, and its sensitivity will be degraded. On the other hand, if a short settling time is to be obtained, then the time constant will be too short to suppress the preamble. This also degrades the sensitivity.

Eg in DECT cordless telephone systems the preamble frequency is 576 kHz, and the subsequent data rate is 1152 kbits/s. During reception of the preamble the 3 dB cut-off frequency of the low-pass filter is typically set to 30 kHz, and during reception of the data the 3 dB cut-off frequency of the low-pass filter is typically set to 100 Hz.

Bluetooth uses a short preamble of only 4 bits, which requires a short settling time. DECT uses a preamble of 16 bits, but here too a short settling time is required, so that the remaining preamble bits, ie the bits not used for settling, can be used for other purposes such as bit synchronisation, equalisation and fast diversity.

Another known method is the min/max detection method, wherein the minimum and the maximum signal amplitudes are measured, and the average is calculated as (min+max)/2. The settling time of this method is very short, but the susceptibility of noise is rather high, which may cause inaccuracy and again a degradation of the sensitivity.

### SUMMARY OF THE INVENTION

There is provided a method and a data slicer circuit for extracting data from a received analogue signal, the received analogue signal having a preamble of a predetermined preamble frequency and a data portion with the data, the data portion having a predetermined data frequency, wherein the circuit comprises a low pass filter for obtaining a signal representing a DC value (Vdc) of the received signal, and a comparator for comparing the received analogue signal to the signal representing a DC value (Vdc) of the received signal, and for generating, in dependence on the comparison of the received analogue signal to the DC value (Vdc) of the received signal, a digital bit stream. According to the invention a filter for rejecting the predetermined preamble frequency is coupled to receive the received analogue signal and to feed a rejection filtered signal to the low pass filter. The rejection filter is preferably a first order notch filter with a 3 dB bandwidth equal to its frequency of maximum rejection, ie Q=1.

The rejection filter effectively rejects the preamble frequency. Consequently, the following low-pass filter for extracting the DC value of the analogue demodulated signal will not have to perform the preamble rejection function, and its cut-off frequency during reception of the preamble can be much higher and is only limited by the high frequency demodulation noise, which should be rejected by the low-pass filter. A rejection filter with Q=1 is simple to implement, and its response time is relatively short, so that a short settling time is ensured. The invention thus offers an uncompromised combination of short settling time and good noise suppression.

### BRIEF DESCRIPTION OF THE DRAWINGS

FIG. 1 shows a receiver with a demodulator and a conventional data slicer circuit,

FIG. 2 shows schematically the structure of preamble and data as transmitted in bursts, and

FIG. 3 shows a DECT receiver with a demodulator and a data slicer circuit according to the invention.

### DETAILED DESCRIPTION OF THE INVENTION

FIG. 2 shows schematically the structure of preamble and data as transmitted in bursts as used eg in DECT cordless telephone systems. Each burst has a preamble followed by a data portion of the burst. The preamble frequency is 576 kHz and has 16 bits of alternating one's and zero's, and the subsequent data portion is 408 bits long with a data rate of 1152 kbits/s. Bursts are transmitted every 10 ms. The invention is also useful in systems using other standards such as Bluetooth, where the preamble is only 4 bits, and in that case it is still more important to have a short settling time.

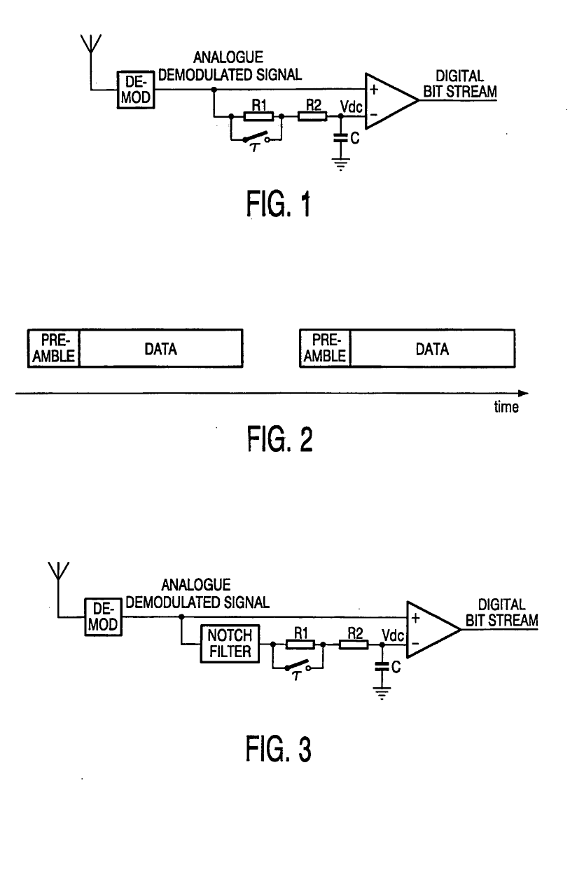

FIG. 3 shows schematically a DECT receiver with an antenna for receiving radio frequency signals and feeding received signals into a demodulator. The demodulator can be of any suitable type known in the art. The demodulator outputs an analogue demodulated signal, which is down-converted from the radio frequency range to 576 kHz superimposed on a DC signal plus some high frequency noise, eg due to weak signal reception. Like in the conventional data slicer in FIG. 1 the analogue demodulated signal is fed to a first input of a comparator, but in accordance with the invention the analogue demodulated signal is fed to a notch filter, which rejects the preamble frequency 576 kHz and preferably has the same bandwidth as its rejection frequency, ie its Q=1. The output from the notch filter is the DC value of the demodulated signal plus the high frequency noise, which are substantially unchanged, and a preamble frequency attenuated in the notch filter.

The output from the notch filter is fed to a first order low pass filter with basically the same structure and function as in the conventional data slicer in FIG. 1. Here, too, the switch is closed during reception of the preamble or at least during a part of the preamble and open during reception of data, and the cut-off frequency of the low-pass filter is determined by the resistor R2 and the capacitor C. However, because the low-pass filter need not reject or attenuate the preamble frequency, its 3 dB cut-off frequency can be selected higher than in the conventional data slicer in FIG. 1, typically 50-60 kHz or higher with a correspondingly shorter time constant resulting in a fast settling of the slicer circuit. This means that the settling time of the data slicer circuit of the invention is only about half of the settling time of the conventional data slicer circuit in FIG. 1.

When the data slicer circuit has settled, the switch is opened, and now the two resistors R1+R2 and the capacitor determine the cut-off frequency of the low-pass filter. The function of the low-pass filter during reception of data is the same as in the conventional data slicer in FIG. 1, namely to give a stable DC voltage Vdc as input to the second input of the comparator.

The comparator is of any suitable type such as a high gain operation amplifier. In a known manner the comparator will output a digital bit stream in dependence on the comparison of the received analogue signal to the DC value (Vdc) of the received signal.

1. A method of extracting data from a received analogue signal, the received analogue signal having a preamble of a predetermined preamble frequency and a predetermined preamble duration, and a data portion with the data, the data portion having a predetermined data rate, the method comprising
obtaining a signal representing a DC value (Vdc) of the received signal,
comparing the received analogue signal to the signal representing a DC value (Vdc) of the received signal, and
generating, in dependence on the comparison of the received analogue signal to the DC value (Vdc) of the received signal, a digital bit stream,
characterized in that, prior to obtaining the signal representing a DC value (Vdc) of the received signal, the received signal is filtered so a to reject the predetermined preamble frequency.

2. A method according to claim 1, characterized in that the signal representing a DC value (Vdc) of the received signal is obtained using a low pass filter.

3. A method according to claim 2, characterized in that the low pass filter is switchable between a first cut-off frequency and a second cut-off frequency lower than the first cut-off frequency, and that during reception of the preamble the low pass filter is switched to the first cut-off frequency, and that during reception of data the low pass filter is switched to the second cut-off frequency.

4. A method according to claim 1, characterized in that the received analogue signal is a demodulated signal.

5. A data slicer circuit for extracting data from a received analogue signal, the received analogue signal having a preamble of a predetermined preamble frequency and a data portion with the data, the data portion having a predetermined data frequency, the circuit comprising
a low pass filter for obtaining a signal representing a DC value (Vdc) of the received signal,
a comparator for comparing the received analogue signal to the signal representing a DC value (Vdc) of the received signal, and for generating, in dependence on the comparison of the received analogue signal to the DC value (Vdc) of the received signal, a digital bit stream,
characterized in that, a filter for rejecting the predetermined preamble frequency is coupled to receive the received analogue signal and to feed a rejection filtered signal to the low pass filter.

6. A data slicer circuit according to claim 5, characterized in that the low pass filter is switchable between a first cut-off frequency and a second cut-off frequency lower than the first cut-off frequency, and that during reception of the preamble the low pass filter is switchable to the first cut-off frequency, and that during reception of data the low pass filter is switchable to the second cut-off frequency.

7. A data slicer circuit according to claim 5, characterized in that the filter for rejecting the predetermined preamble frequency is a notch filter.

8. A data slicer circuit according to claim 7, characterized in that the notch filter is a first order notch filter with a 3 dB bandwidth equal to its frequency of maximum rejection.
